(19) United States
(12) Patent Application Publication
(10) Pub. No.: US 2010/0208222 A1
(43) Pub. Date: Aug. 19, 2010

(54) Exposure apparatus and method to measure beam position and assign address using the same

(75) Inventors: Ul Tae Kim, Suwon-si (KR); Hi Kuk Lee, Yongin-si (KR); Sang Don Jang, Ansan-si (KR); Sang Hyun Park, Yongin-si (KR); Ho Seok Choi, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD.,, Suwon (KR)

(21) Appl. No.: 12/656,093

(22) Filed: Jan. 15, 2010

(30) Foreign Application Priority Data
Feb. 17, 2009 (KR) 10-2009-12748

(51) Int. Cl. G03B 27/42; G01B 11/14

(52) U.S. Cl. 355/53; 356/614

(57) ABSTRACT

An exposure apparatus and a method to measure a beam position and assigning an address using the same are disclosed. The exposure apparatus includes a Digital Micromirror Device (DMD) having a plurality of micromirrors, each micromirror to modulate light projected from a light source and project a modulated DMD beam onto an exposed surface, a measurement mask to measure positions of the DMD beams projected onto the exposed surface, a sensor to detect light intensities of the DMD beams measured by the measurement mask, and a controller to determine the positions of the DMD beams according to the detected light intensities.

### CROSS-REFERENCE TO RELATED APPLICATIONS

This application claims the benefit of Korean Patent Application No. 2009-12748, filed on Feb. 17, 2009 in the Korean Intellectual Property Office, the disclosure of which is incorporated herein by reference.

### BACKGROUND

1. Field

One or more embodiments of the present disclosure relate to a method to measure the position of each Digital Micromirror Device (DMD) beam and to assign an address to the DMD beam in accordance with the measured position, for exposure, in order to expose a pattern accurately in a digital exposure apparatus using the DMD.

2. Description of the Related Art

Generally, a pattern is formed onto a substrate for a Flat Panel Display (FPD) such as a Liquid Crystal Display (LCD) or a Plasma Display Panel (PDP) by depositing a pattern material on the substrate and exposing the pattern material selectively using a photomask, thus selectively eliminating pattern material portions having changed chemical properties or the other portions.

However, along with an increase in substrate size and accuracy of a pattern formed on an exposed surface, digital exposure apparatuses are used without a photomask. A digital exposure apparatus exposes a pattern by projecting optical beams onto a substrate based on a control signal generated based on pattern information by means of a DMD.

The DMD is a mirror device in which a plurality of micromirrors each having a reflection surface with a tilt angle varying according to a control signal are two dimensionally arranged on a semiconductor substrate such as a silicon substrate. The tilt angles of the reflection surfaces of the micromirrors are changed by the electro static force of potentials accumulated in memory cells. The DMD-based digital exposure device performs image exposure with a high resolution using an exposure head. The exposure head collimates a laser beam emitted from a light source onto a lens system, reflects the laser beam from a plurality of micromirrors of the DMD positioned at the focal point of the lens system, outputs the reflected beams through a plurality of beam emitters, and focuses the emitted beams onto the lenses of a lens system having an optical device such as a micro lens array, each lens corresponding to one pixel, thus, imaging the beams with a small spot diameter on the exposed surface of a photosensitive material (a target exposure member).

In this manner, the DMD-based digital exposure apparatus modulates a laser beam by controlling on/off of each micromirror of the DMD and exposes a pattern by projecting the modulated laser beam onto the exposed surface. When a high-accuracy circuit pattern is exposed on a substrate, the beam projected onto the exposed surface is deformed by distortion, thus generating position errors, because distortion is inherent to the lenses of an illumination optical system and the lenses of an imaging optical system in the exposure head. Also, the accuracy of the DMD itself may bring about position errors and, as a result, the resulting pattern may not match to a designed circuit pattern accurately.

Conventionally, to correct the position errors of beams, slits and a photosensor that detects light transmitted through the slits are provided on an end portion of the exposed surface. Laser beams that have been emitted from a plurality of micromirrors of the DMD and transmitted through the slits are detected and the positions of the detected laser beams on the exposed surface are measured, thus measuring the positions of the beams spots of the micromirrors of the DMD. Then relative position errors are calculated based on position information about the beam spots and position information about the reflection surfaces of the micromirrors and corrected. This conventional position error correction technique takes a long time and requires a stable environment to acquire the coordinates of tens of thousands of beams of the DMD. Moreover, since a signal indicating the start and end of a beam transmitted through a slitneeds a light intensity of a minimum predetermined value such that the signal is distinguishable from noise, setting to measure beam positions is significant but very difficult. As a consequence costs for the conventional technique are high.

### SUMMARY

Therefore, one aspect of the disclosure is to provide a method to quickly measure the position of each DMD beam which reflects a position error, detect an address corresponding to the exposed pattern position for the DMD beam, and assign the address to the DMD beam in order to expose an accurate pattern in a digital exposure apparatus using a DMD.

Additional aspects and/or advantages will be set forth in part in the description which follows and, in part, will be apparent from the description, or may be learned by practice of the disclosure.

In accordance with one aspect of the present disclosure, an exposure apparatus includes a Digital Micromirror Device (DMD) having a plurality of micromirrors, each micromirror to modulate light projected from a light source and project a modulated DMD beam onto an exposed surface, a measurement mask to measure positions of the DMD beams projected onto the exposed surface, a sensor to detect light intensities of the DMD beams measured by the measurement mask, and a controller to determine the positions of the DMD beams according to the detected light intensities.

The exposure apparatus may further include a stage to move a photosensitive material having the exposed surface and the measurement mask may be a slit plate fixed or detachably installed to the stage.

The slit plate may have a length equal to a width of the stage and a plurality of patterned detection slits to transmit the DMD beams.

The plurality of detection slits may be arranged to be apart from one another by a DMD beam spacing in a plurality of arrays on the slit plate.

The plurality of detection slits may be arranged in a plurality of groups corresponding to groups of the DMD beams on the slit plate.

Each of the plurality of detection slits may have a pattern shape to receive a circular or square beam uniformly.

The controller may detect light intensities of all of the DMD beams at each position of the plurality of micromirrors by sequentially turning on/off the plurality of micromirrors, while moving the DMD stepwise to a predetermined position.

The controller may determine a position of each DMD beam having a maximum light intensity among all positions detected for the DMD beam to be a position value of the DMD beam.

The controller may measure the position of each DMD beam by reducing a beam measurement area according to a position deviation of the DMD beam.

The controller may map an address to the position value of the DMD beam according to a measurement resolution of the measurement mask.

In accordance with another aspect of the present disclosure, a method to measure a position of a beam includes modulating light from a light source and projecting a modulated Digital Micromirror Device (DMD) beam onto an exposed surface by each micromirror of a DMD having a plurality of micromirrors, measuring positions of the DMD beams projected onto the exposed surface by a measurement mask, detecting light intensities of the DMD beams measured by the measurement mask by a sensor, and determining a position of each DMD beam having a maximum light intensity to be a position value of the DMD beam.

The measurement mask may be a slit plate on which a plurality of detection slits are patterned to transmit the DMD beams.

The method may further include sequentially turning on/off the plurality of micromirrors, while moving the DMD stepwise to a predetermined position, and the step of detecting the light intensities includes detecting the light intensities of all of the DMD beams at each position of the plurality of micromirrors by the sensor.

The method may further include measuring the position of each DMD beam by reducing a beam measurement area according to a position deviation of the DMD beam.

In accordance with a further aspect of the present disclosure, a method to measure a position of a beam includes modulating light from a light source and projecting a modulated Digital Micromirror Device (DMD) beam onto an exposed surface by each micromirror of a DMD having a plurality of micromirrors, measuring positions of the DMD beams projected onto the exposed surface by a measurement mask, detecting light intensities of the DMD beams measured by the measurement mask by a sensor, determining a position of each DMD beam having a maximum light intensity to be a position value of the DMD beam, and mapping an address to the position value of the DMD beam according to a measurement resolution of the measurement mask.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a schematic perspective view of an exposure apparatus according to an exemplary embodiment of the present disclosure;

FIG. 2 is a schematic perspective view illustrating a state where exposure heads of an optical unit expose a photosensitive material according to an exemplary embodiment of the present disclosure;

FIG. 3 is a perspective view of a beam position measurer to measure the positions of DMD beams projected by each exposure head in the optical unit according to an exemplary embodiment of the present disclosure;

FIG. 4 is a schematic perspective view of an exposure head according to an exemplary embodiment of the present disclosure;

FIG. 5 is an enlarged perspective view of a DMD according to an exemplary embodiment of the present disclosure;

FIGS. 6A and 6B illustrate an operation of the DMD according to an exemplary embodiment of the present disclosure;

FIG. 7 is a control block diagram of an exposure apparatus according to an exemplary embodiment of the present disclosure;

FIG. 8 illustrates the principle of measuring a beam position in a beam position measurer according to an exemplary embodiment of the present disclosure;

FIG. 9 illustrates an operation to measure the X position of a single beam based on the principle of FIG. 8;

FIG. 10 illustrates an operation to measure the X positions of multiple beams based on the principle of FIG. 8;

FIG. 11 illustrates an operation to measure a beam position, reflecting a position error in the beam position measurer according to an exemplary embodiment of the present disclosure;

FIG. 12 illustrates a method to assign an address to a beam using the beam position measurer according to an exemplary embodiment of the present disclosure;

FIG. 13 illustrates measurement mask patterns in a beam position measurer according to another exemplary embodiment of the present disclosure; and

FIG. 14 illustrates measurement mask patterns in a beam position measurer according to a further exemplary embodiment of the present disclosure.

### DETAILED DESCRIPTION

Reference will now be made in detail to the embodiments of the present disclosure, examples of which are illustrated in the accompanying drawings, wherein like reference numerals refer to the like elements throughout.

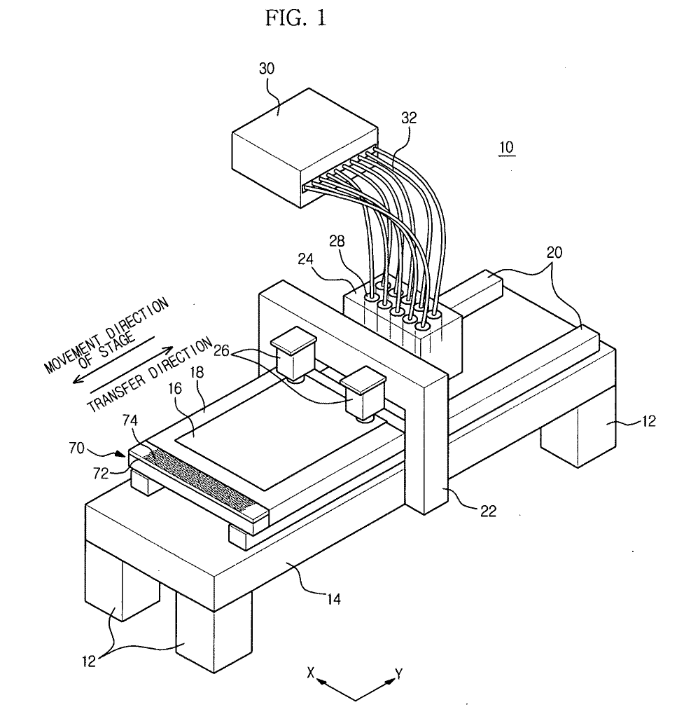

FIG. 1 is a schematic perspective view of an exposure apparatus according to an exemplary embodiment of the present disclosure.

Referring to FIG. 1, an exposure apparatus 10 according to an exemplary embodiment of the present disclosure is configured to be a flat bed type. The exposure apparatus 10 may include, for example, a thick plate-type installation mount 14 supported by four supports 12, a stage 18 mounted on the installation mount 14, which fixes an object to be exposed on the installation mount 14, for example, a photosensitive material 16 that will be formed on a surface of a substrate for a Printed Circuit Board (PCB), an LCD, a PDP, or an FPD thereon and which moves in a Y-axis direction, and two guides 20 installed on the installation mount 14, extending along a movement direction of the stage 18. The stage 18 is elongated along its movement direction and is supported by the guides 20 so that it may make a reciprocal movement.

A gate 22 shaped into a “a” shape is installed at the center of the installation mount 14, straddling the movement path of the stage 18. The ends of the gate 22 are fixed at both sides of the installation mount 14, respectively. An optical unit 24 is installed at one side of the gate 22 to expose the photosensitive material 16 loaded on the stage 18, and a pair of position detection sensors 26 are installed at the other side of the gate 22 to detect whether the stage 18 has passed. The optical unit 24 and the position detection sensors 26 are attached onto the gate 22 over the movement path of the stage 18.

The optical unit 24 is provided with a plurality of exposure heads 28 to spatially modulate multi-beam laser light emitted from a light source 30 according to an intended pattern of image data and project the modulated multiple beams onto the photosensitive material 16, which is sensitive to the wavelengths of the multiple beams. Each exposure head 28 is connected to an optical fiber 32 drawn from the light source 30.

The light source 30 includes a semiconductor laser and an optical system to control multi-beam laser light emitted from the semiconductor laser. The light source 30 feeds the multi-beam laser light to incident ends of the exposure heads 28 of the optical unit 25 through the optical fibers 32.

Therefore, the exposure apparatus 10 scans and exposes the target exposure member, that is, the photosensitive material 16, moving the photosensitive material 16 loaded on the stage with respect to the fixed optical unit 24.

In the exposure apparatus 10, a beam position measurer 70 is installed in conjunction with the stage 18, to measure the positions of exposure beams (DMD beams) that the exposure heads 28 of the optical unit 24 project onto the photosensitive material 16.

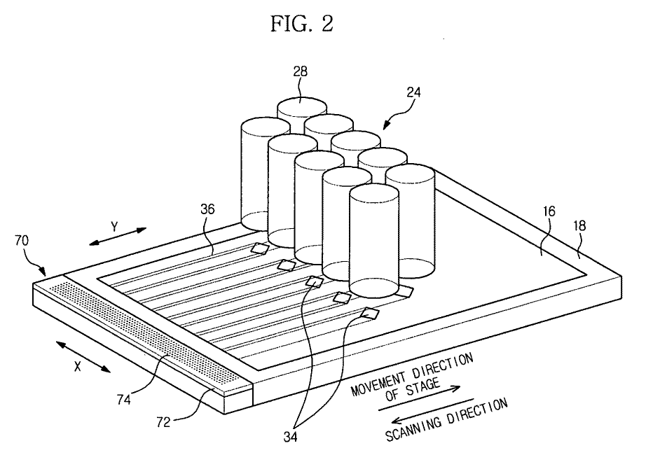

FIG. 2 is a schematic perspective view illustrating a state where the exposure heads of the optical unit expose the photosensitive material according to an exemplary embodiment of the present disclosure.

Referring to FIG. 2, the optical unit 24 includes the plurality of exposure heads 28 arranged in a matrix-like array with m rows and n columns (e.g. two rows and five columns)

Exposure regions 34 exposed by the exposure heads 28 are shaped into rectangles each having a short side along a scanning direction. As the stage 18 moves, a band-shaped final exposure region 36 is formed on the photosensitive material 16 by each exposure head 28.

Exposure heads 28 in a line in each row are arranged such that exposure heads 28 in each column are out of line by a predetermined degree with respect to an array direction and thus the band-shaped final exposure regions 36 are arranged in a direction orthogonal to the scanning direction, with no gap in between.

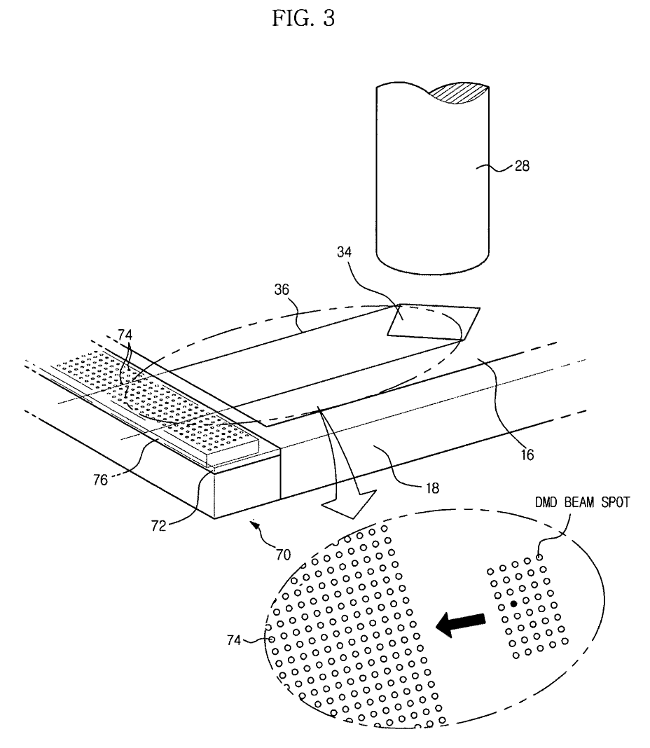

FIG. 3 is a perspective view of the beam position measurer to measure the positions of DMD beams projected by each exposure head in the optical unit according to an exemplary embodiment of the present disclosure.

Referring to FIG. 3, the beam position measurer 70 includes a slit plate 72 fixed on the stage 18 or detachable from the stage 18, a plurality of detection slits 74 punctured into the slit plate 72, to transmit beams projected from the DMD (i.e. DMD beams), and a photosensor 76 to detect light intensity signals of the DMD beams transmitted through the detection slits 74.

The slit plate 72 is a measurement mask formed by coating a light-shielding thin chrome film on an oval quartz glass substrate with a length equal to the width of the stage 18 and patterning the detection slits 74 at a predetermined number of positions on the chrome film to allow DMD beams to transmit therethrough, such that a plurality of patterns for the detection slits 74 may be arranged, apart from one another by a DMD beam interval in an array, to detect the positions of DMD beams.

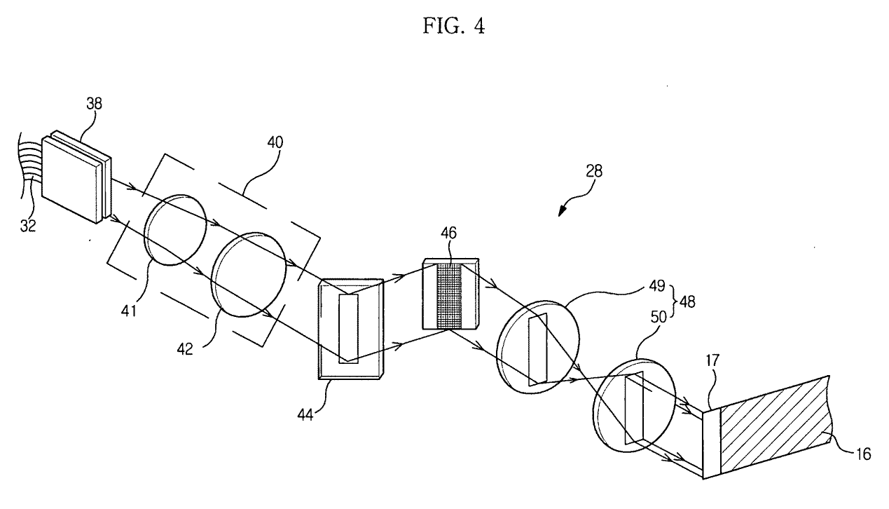

FIG. 4 is a schematic perspective view of an exposure head according to an exemplary embodiment of the present disclosure.

Referring to FIG. 4, each exposure header 28 includes a compensation lens system 40 to emit multi-beam laser light incident from an optical emitter 38 of an optical fiber 32 after compensation, a mirror 44 to reflect the light emitted from the compensation lens system to a DMD 46, the DMD 46 to modulate part of the light reflected from the mirror 44 at a different reflection angle and thus to project DMD beams with a predetermined pattern, and a condenser lens system 48 to form an image on an exposed surface 17 of the photosensitive material 16 with the modulated DMD beams.

The compensation lens system 40 has a first compensation lens 41 to render the light emitted from the optical emitter 38 to be uniform and a second compensation lens 42 to condense the light passed through the first compensation lens 41 onto the mirror 44. Thus, the light incident from the optical emitter 38 may impinge on the mirror 44 with a uniform light intensity distribution.

The mirror 44 is formed to have a reflection surface on one surface thereof to reflect the light passed through the compensation lens system 40 onto the DMD 46.

The DMD 46 is a spatial light modulation device to modulate an incident light for each pixel according to an intended pattern. It is also a mirror device in which a plurality of micromirrors 45 having reflection surfaces with angles varying based on a control signal generated based on image data are arranged two-dimensionally in L rows and M columns on a semiconductor substrate such as a silicon substrate. The DMD 46 reflects DMD beams in a predetermined pattern onto the condenser lens system 48 by scanning the exposed surface 17 in a predetermined direction.

The condenser lens system 48 includes a first condenser lens 49 and a second condenser lens 50. The position of imaging the DMD beams from the condenser lens system 48 is controlled by adjusting the distance between the first condenser lens 49 and the second condenser lens 50. This condenser lens system 48 projects the DMD beams modulated by the DMD 46 onto the exposed surface 17 of the photosensitive material 16. Thus, the photosensitive material 16 on the exposed surface 17 of the substrate to be exposed is hardened or softened.

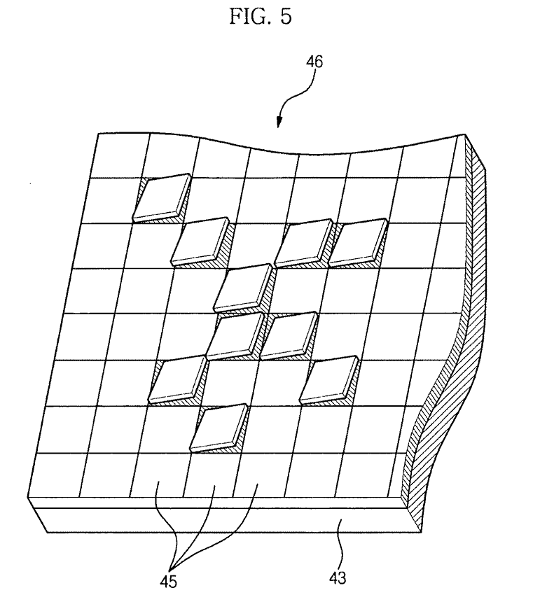

FIG. 5 is an enlarged perspective view of the DMD according to an exemplary embodiment of the present disclosure.

Referring to FIG. 5, the DMD 46 is a mirror device in which a plurality of micromirrors 45 forming pixels are placed in the form of a lattice on a memory cell 43. A material having a high reflectance such as aluminum is deposited on the surfaces of the micromirrors 45.

When a digital signal is written into the memory cell 43 in the DMD 46, each of the micromirrors 62 is diagonally inclined within a predetermined angle (e.g.)12° with respect to the substrate having the DMD 46 thereon. On-off control for each of the micromirrors 62 is performed by a later-described controller 62. Light reflected by micromirrors 45 in an on state is modulated to an exposure state and exposes the exposed surface 17 through the condenser lens system 48. On the other hand, light reflected by micromirrors 45 in an off state is modulated to a non-exposure state and thus does not expose the exposed surface 17.

The DMD 46 may be tilted slightly such that its short side is at a predetermined angle with the scanning direction.

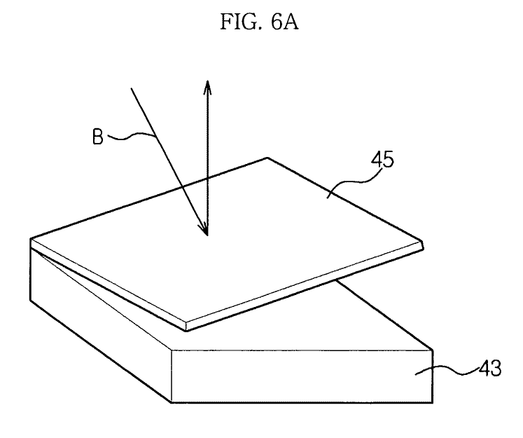

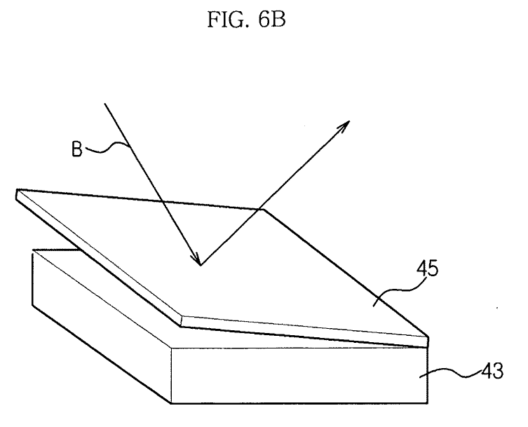

FIGS. 6A and 6B illustrate an operation of the DMD according to an exemplary embodiment of the present disclosure.

FIG. 6A illustrates a state where a micromirror 45 is inclined by +12° in an on state and FIG. 6B illustrates a state where the micromirror 45 is inclined by −12° in an off state Thus, a beam B incident on the DMD 46 is reflected in the inclined direction of the micromirror 45 by controlling inclination of the micromirror 45 for each pixel of the DMD 45 according to an image signal generated based on image data.

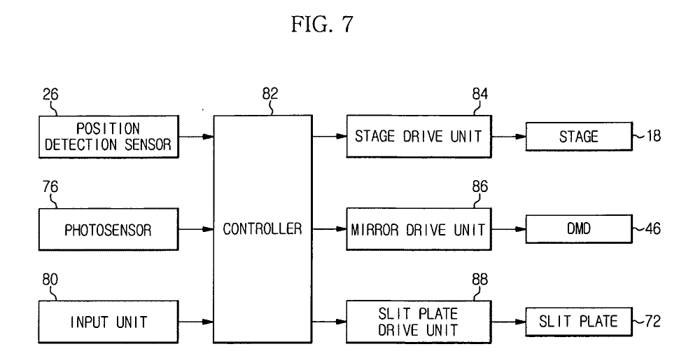

FIG. 7 is a control block diagram of an exposure apparatus according to an exemplary embodiment of the present disclosure. The exposure apparatus includes an input unit 80, a controller 82, a stage drive unit 84, a mirror drive unit 86, and a slit plate drive unit 88.

The input unit 80 transmits information indicating an exposure scheme (a Y-axis movement step for the stage 18, an X-axis spacing between exposure beams, the number of exposure beams, the shape of exposure beams, etc.) to the controller 82.

The controller 82 provides overall control to the exposure apparatus 10. The controller 82 measures the positions of DMD beams projected from the DMD 46 of each exposure head 28 through the beam position measurer 70, while moving the stage 18 a predetermined movement step each time and assigns addresses to the beams.

The stage drive unit 84 drives the stage 18 so that the stage 18 moves the guides 20 a predetermined step each time according to a control signal received from the controller 82. The mirror drive unit 86 drives on/off the DMD 46 according to a control signal received from the controller 82, to expose the exposed surface 17 with beams in an intended pattern.

The slit plate drive unit 88 drives the slit plate 72 according to a control signal received from the controller 82. While it has been described that the slit plate 72 is integrated with the stage 18 in an exemplary embodiment of the present disclosure, the present disclosure is not limited thereto. For example, it is clear that the slit plate 72 may be separated from the stage 18 in order to measure the positions of DMD beams separately.

The exposure apparatus having the above-described configuration, an operation to measure the positions of beams and assigning addresses to the beams in the exposure apparatus, and the effects of the operation will be described below.

The input unit 80 transmits information indicating an exposure scheme (a Y-axis movement step for the stage 18, an X-axis spacing between exposure beams, the number of exposure beams, the shape of exposure beams, etc.) to the controller 82.

The controller 82 outputs control signals to the stage drive unit 84 and the mirror drive unit 86 according to the exposure scheme.

The stage drive unit 84 consequently moves the stage 18 the predetermined movement step along the Y axis according to the received control signal, so that the exposed surface 17 of the photosensitive material 16 loaded on the stage 18 is exposed with DMD beams.

Simultaneously, the mirror drive unit 86 drives the DMD 46 according to the received control signal, so that the DMD 46 modulates light incident through the compensation lens system 40 for each pixel according to an intended pattern and reflects the beams of the predetermined pattern onto the condenser lens system 48.

To be more specific, laser light emitted from the light source 30 is provided to the optical unit 24 through the optical fibers 32. Each exposure head 28 in the optical unit 24 projects the received light onto pixels corresponding to the micromirrors 45 of the DMD 46 through the compensation lens system 40 and the mirror 44.

The micromirrors 45 of the DMD 46 reflect the beams by turning on or off according to the control signal from the controller 82. Light reflected from on-state micromirrors 45 is modulated to an exposure state and exposes the exposed surface 17 through the condenser lens system 48, while light reflected from off-state micromirrors 45 is modulated to a non-exposure state and does not expose the exposed surface 17.

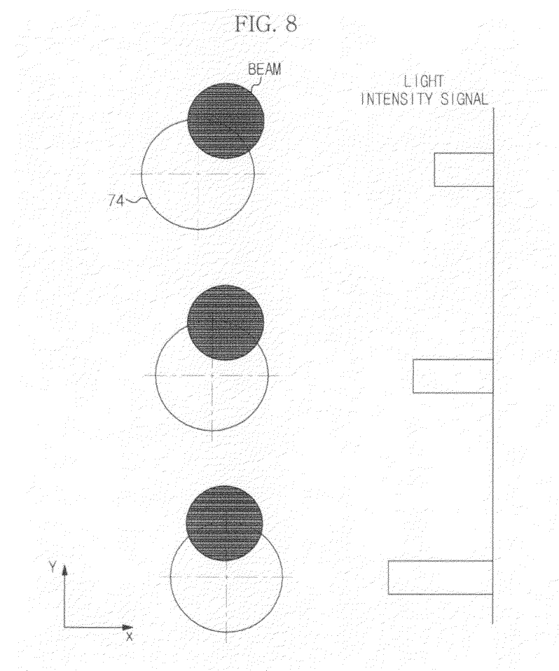

FIG. 8 illustrates the principle of measuring a beam position in the beam position measurer according to an exemplary embodiment of the present disclosure. A description is made of measuring the position of a single beam (DMD beam) projected from a micromirror 45 of the DMD 46.

Referring to FIG. 8, each black spot represent a beam (a DMD beam) projected from the DMD 46 and circles represent detection slits 74 through which the DMD beam may be transmitted. The inside area of each detection slit 74 is a DMD beam measurement area.

As noted from FIG. 8, as the DMD beam's movement deviates from the origin of a circle along the X axis, maintaining a Y-axis spacing, the light intensity signal of a beam detected by the photosensor 76 varies depending on how much of the measurement area of a detection slit 74 is occupied by the DMD beam.

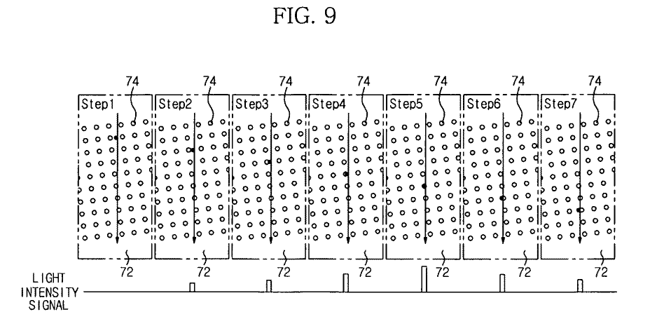

FIG. 9 illustrates an operation to measure the X position of a single beam based on the principle of FIG. 8. The position measuring operation is about measuring the position of the beam, while a measurement point and a plurality of detection slits 74 are shifted by a Y-axis measurement resolution and micromirrors 45 are inclined as much as the inclination of the DMD 46.

Referring to FIG. 9, when a single DMD beam passes through the beam position measurer 70 in an arrowed direction in a step & scan manner, a light intensity signal detected by the photosensor 76 has a maximum level at the time the DMD beam accurately coincides with the measurement area of the detection slit 74. A signal detection position where the light intensity signal has the maximum level corresponds to an efficient exposure position and thus is determined to be the X position of the DMD beam.

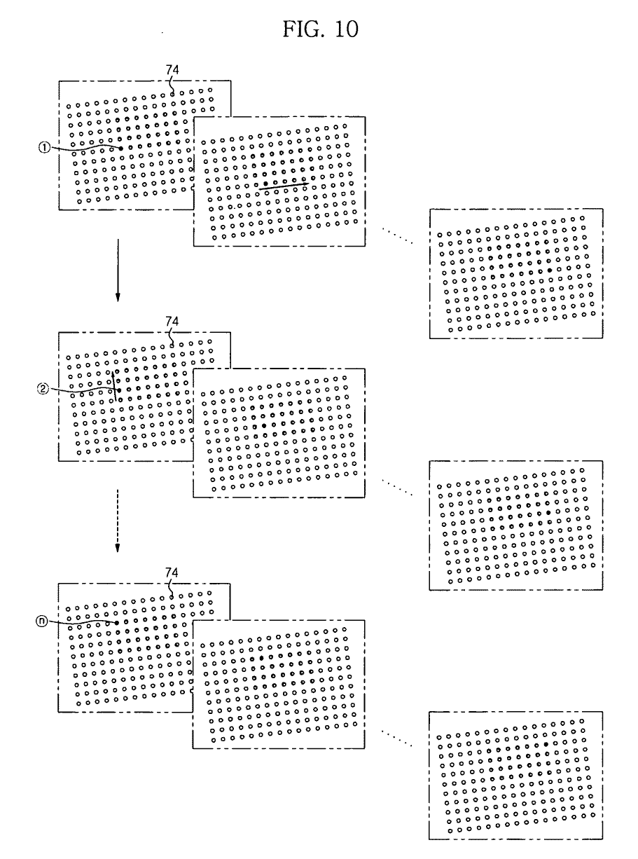

FIG. 10 illustrates an operation to measure the X positions of multiple beams based on the principle of FIG. 8. The position measuring operation is about measuring the X positions of a plurality of DMD beams when the DMD beams pass through a plurality of detection slits 74 of the beam position measurer 70 in an arrowed direction.

Referring to FIG. 10, only one beam should be on at one time in order to measure the position of the beam. To measure the positions of entire DMD beams, satisfying this condition, the DMD beams are measured in their positions at a first measurement point \textcircled{1} determined according to a Y-axis movement step by sequentially turning on/off the DMD beams. Then, at the next measurement point spaced from the first measurement point \textcircled{1} by the Y-axis movement step, for example, at a second measurement point \textcircled{2}, all of the DMD beams are measured in the same manner. In this way, data is acquired by moving n steps to an intended point, for example, to an n^{th} measurement point \textcircled{n} and the X position of each beam at a point where it has a maximum-level light intensity signal is determined to be the X position of the beam. Meanwhile, the Y position of each beam may be determined by performing the above operation with respect to the X-axis direction through step & scan in the same manner.

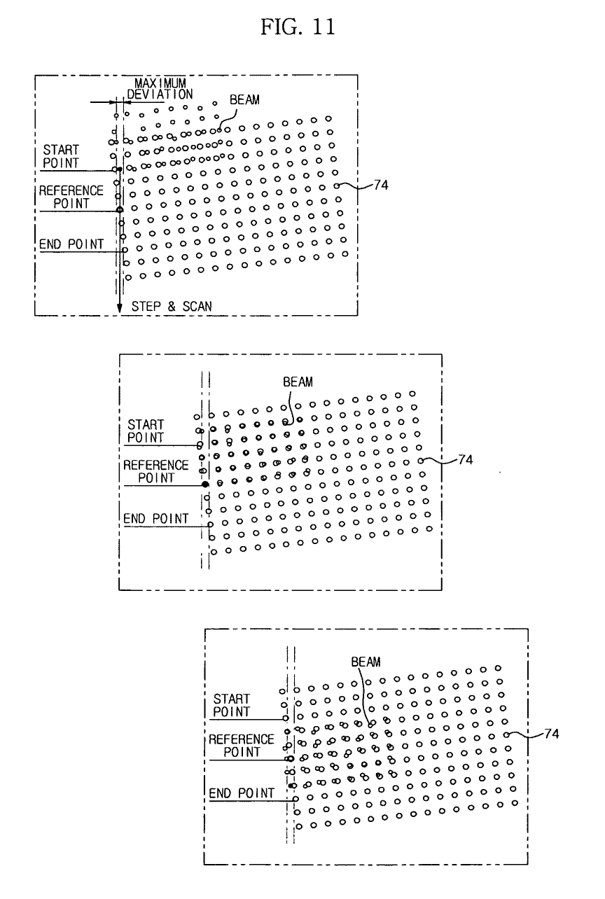

FIG. 11 illustrates an operation to measure a beam position, reflecting a position error in the beam position measurer according to an exemplary embodiment of the present disclosure. The beam position measuring operation aims to reduce a measurement time by limiting a measurement area according to a position error of beams.

Referring to FIG. 11, if the position error (maximum deviation) of beams is 1 μm, Y values of an area ranging from an X-axis distance −1 μm to an X-axis distance +1 μm are calculated and a measurement area (defined by a start point and an end point) is limited to a beam deviation area expected based on the Y values. When the positions of beams are measured in the measurement area, the time taken to measure the positions of total DMD beams is shortened.

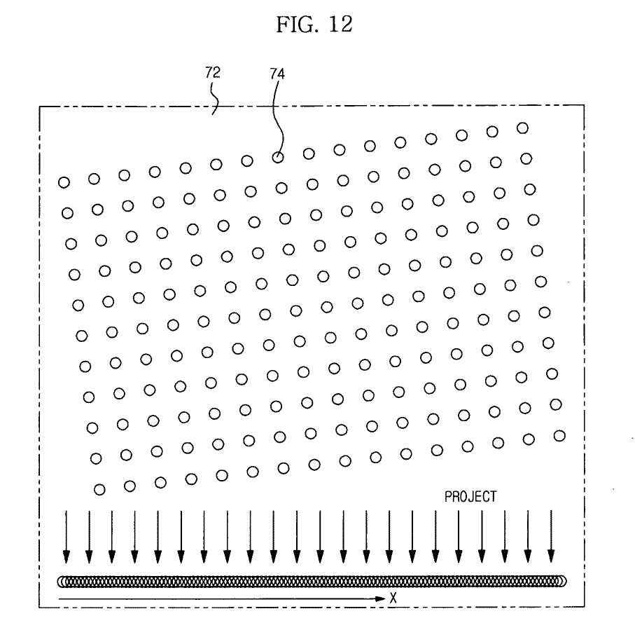

FIG. 12 illustrates a method to assign an address to a beam using the beam position measurer according to an exemplary embodiment of the present disclosure. FIG. 12 illustrates a state in which each of the beams is projected onto one position, irrespective of its Y position.

Referring to FIG. 12, the slit plate 72 of the beam position measurer 70 according to the exemplary embodiment of the present disclosure has a predetermined beam spacing according to a mask design. Thus, when an intended exposure pattern is represented in the form of a pixel pattern, on/off mapping is simply performed by detecting beam positions of an area to be exposed in the exposure pattern. If beams are measured in the method illustrated in FIG. 10, the measurement resolution of the slit plate 72 being a measurement mask becomes discrete according to the position resolution of measurement points. In other words, a beam has a single position corresponding to a detection slit 74 onto which the beam is projected. Since the position is a determined position value for the beam, the position value of the beam is detected and mapped. Therefore, on positions of the exposure pattern are mapped to the positions of detection slits onto which the beams are projected and then the beams are on.

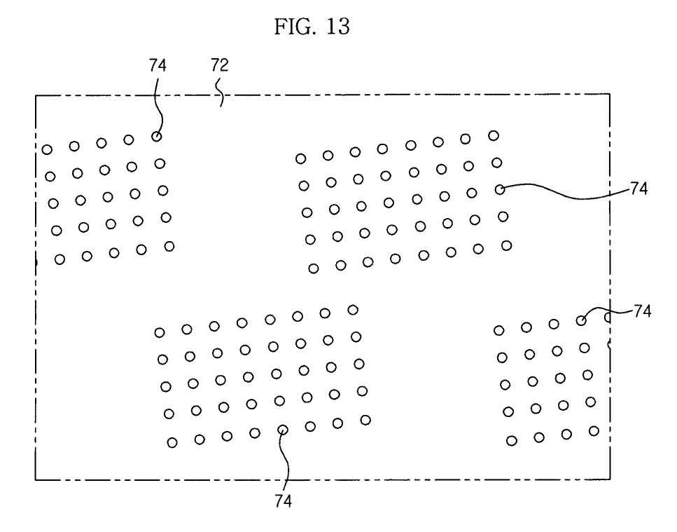

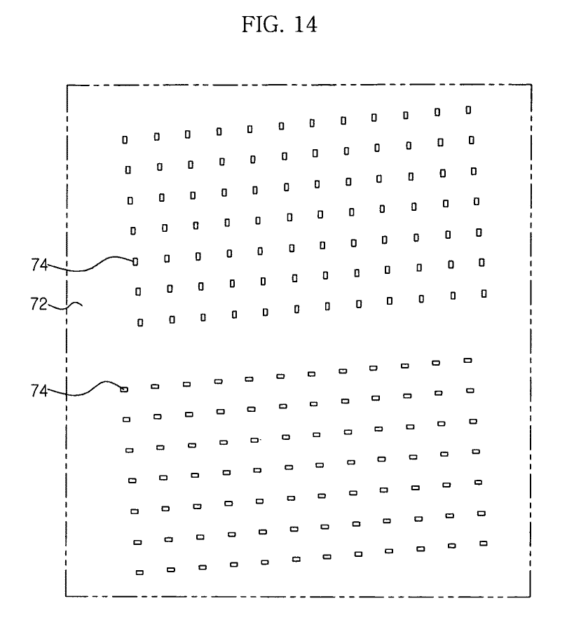

FIG. 13 illustrates measurement mask patterns in the beam position measurer according to another exemplary embodiment of the present disclosure and FIG. 14 illustrates measurement mask patterns in the beam position measurer according to a further exemplary embodiment of the present disclosure.

Referring to FIGS. 13 and 14, the mask patterns of the slit plate 72 may be formed into any shape, as far as they receive circular or square beams uniformly. Also, the mask patterns may be grouped in correspondence with groups of DMD beams and disposed on a per section basis. A dummy pattern may be interposed between a plurality of detection slits 74.

As is apparent from the above description, the time taken to measure the position of each DMD beam with which to expose an accurate pattern is reduced in the digital exposure apparatus using a DMD. Also, there is no need to use a physical mask to measure the positions of DMD beams. The exemplary embodiments of the present disclosure are applicable to every product and field using a DMD, such as a display, a digital exposure apparatus for semiconductors, a light-based digital printing product, a Digital Lighting Processor (DLP), etc.

The method to measure a position of a beam according to the above-described embodiments may be recorded in computer-readable media or processor-readable media including program instructions to implement various operations embodied by a computer or processor. The media may also include, alone or in combination with the program instructions, data files, data structures, and the like.

Examples of computer-readable media or processor-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may also be configured to act as one or more software modules in order to perform the operations of the above-described embodiments, or vice versa. The method to measure a position of a beam may be executed on a general purpose computer or processor or may be executed on a particular machine such as the network connection system or USB input/output server device described herein.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. An exposure apparatus comprising:
a Digital Micromirror Device (DMD) having a plurality of micromirrors, each micromirror to modulate light projected from a light source and to project a modulated DMD beam onto an exposed surface;
a measurement mask to measure positions of the DMD beams projected onto the exposed surface;
a sensor to detect light intensities of the DMD beams measured by the measurement mask; and
a controller to determine the positions of the DMD beams according to the detected light intensities.

2. The exposure apparatus according to claim 1, further comprising a stage to move a photosensitive material having the exposed surface, wherein the measurement mask is a slit plate fixed or detachably installed to the stage.

3. The exposure apparatus according to claim 2, wherein the slit plate has a length equal to a width of the stage and a plurality of patterned detection slits to transmit the DMD beams.

4. The exposure apparatus according to claim 3, wherein the plurality of patterned detection slits are arranged to be apart from one another by a DMD beam spacing in a plurality of arrays on the slit plate.

5. The exposure apparatus according to claim 3, wherein the plurality of patterned detection slits are arranged in a plurality of groups corresponding to groups of the DMD beams on the slit plate.

6. The exposure apparatus according to claim 3, wherein each of the plurality of patterned detection slits has a pattern shape to receive a circular or square beam uniformly.

7. The exposure apparatus according to claim 1, wherein the controller detects light intensities of all of the DMD beams at each position of the plurality of micromirrors by sequentially turning on/off the plurality of micromirrors, while moving the DMD stepwise to a predetermined position.

8. The exposure apparatus according to claim 7, wherein the controller determines a position of each DMD beam having a maximum light intensity among all positions detected for the DMD beam to be a position value of the DMD beam.

9. The exposure apparatus according to claim 8, wherein the controller measures the position of each DMD beam by reducing a beam measurement area according to a position deviation of the DMD beam.

10. The exposure apparatus according to claim 8, wherein the controller maps an address to the position value of the DMD beam according to a measurement resolution of the measurement mask.

11. A method to measure a position of a beam, comprising:
modulating light from a light source and projecting a modulated Digital Micromirror Device (DMD) beam onto an exposed surface by each micromirror of a DMD having a plurality of micromirrors;
measuring positions of the DMD beams projected onto the exposed surface by a measurement mask;
detecting light intensities of the DMD beams measured by the measurement mask by a sensor; and
determining a position of each DMD beam having a maximum light intensity to be a position value of the DMD beam.

12. The method according to claim 11, wherein the measurement mask is a slit plate on which a plurality of detection slits are patterned to transmit the DMD beams.

13. The method according to claim 12, wherein the plurality of detection slits are arranged to be apart from one another by a DMD beam spacing in a plurality of arrays on the slit plate.

14. The method according to claim 12, wherein the plurality of detection slits are arranged in a plurality of groups corresponding to groups of the DMD beams on the slit plate.

15. The method according to claim 11, further comprising sequentially turning on/off the plurality of micromirrors, while moving the DMD stepwise to a predetermined position, wherein the step of detecting the light intensities comprises detecting the light intensities of all of the DMD beams at each position of the plurality of micromirrors by the sensor.

16. The method according to claim 11, further comprising measuring the position of each DMD beam by reducing a beam measurement area according to a position deviation of the DMD beam.

17. A computer-readable storage medium encoded with computer readable code comprising a program for implementing the method of claim 11.

18. A method to measure a position of a beam, comprising:
modulating light from a light source and projecting a modulated Digital Micromirror Device (DMD) beam onto an exposed surface by each micromirror of a DMD having a plurality of micromirrors;
measuring positions of the DMD beams projected onto the exposed surface by a measurement mask;
detecting light intensities of the DMD beams measured by the measurement mask by a sensor;
determining a position of each DMD beam having a maximum light intensity to be a position value of the DMD beam; and
mapping an address to the position value of the DMD beam according to a measurement resolution of the measurement mask.

19. A computer-readable storage medium encoded with computer readable code comprising a program for implementing the method of claim 18.
